(19) United States
(12) Patent Application Publication
(10) Pub. No.: US 2025/0222867 A1
(43) Pub. Date: Jul. 10, 2025

(54) VEHICULAR EXTERIOR REARVIEW MIRROR ASSEMBLY WITH EXTEND / RETRACT MECHANISM

(71) Applicant: Magna Mirrors of America, Inc., Holland, MI (US)

(72) Inventor: Matthew V. Steffes, Grand Rapids, MI (US)

(21) Appl. No.: 19/013,040

(22) Filed: Jan. 8, 2025

Related U.S. Application Data
(60) Provisional application No. 63/619,424, filed on Jan. 10, 2024.

(51) Int. Cl. B60R 1/072

(52) U.S. Cl. CPC B60R 1/072

(57) ABSTRACT

A vehicular exterior rearview mirror assembly includes a mounting structure and a mirror head accommodating a mirror reflective element. With the mirror assembly mounted at a side of the vehicle, the mirror head is translationally movable along a rail relative to the mounting structure between a retracted position and an extended position. An actuator is electrically operable to pivotally adjust a first end of a driving link that is pivotally attached at the mirror head. A second end of the driving link is pivotally attached at a first end of a pivot link. A second end of the pivot link is pivotally attached at the mounting structure. The second end of the driving link pivots relative to the first end of the pivot link to impart translational movement of the actuator and the mirror head along the rail between the retracted position and the extended position.

### CROSS REFERENCE TO RELATED APPLICATION

The present application claims the filing benefits of U.S. provisional application Ser. No. 63/619,424, filed Jan. 10, 2024, which is hereby incorporated herein by reference in its entirety.

### FIELD OF THE INVENTION

The present invention relates generally to the field of exterior rearview mirror assemblies for vehicles and, more particularly, to extendable and retractable exterior rearview mirror assemblies for vehicles.

### BACKGROUND OF THE INVENTION

It is known to provide an automotive exterior rearview mirror assembly that may be extended and retracted, such as for trailer towing applications, where the mirror assembly may be extended to provide enhanced rearward viewing to the driver of the trailer pulling vehicle. Examples of extendable and retractable mirror assemblies are described in U.S. Pat. Nos. 5,483,385; 6,116,743; 6,213,609; 6,239,928; 6,276,808; 6,325,518; 6,394,616 and/or 6,497,491, which are hereby incorporated herein by reference in their entireties.

### SUMMARY OF THE INVENTION

An exterior rearview mirror assembly of the vehicle includes a mounting structure configured for attachment at a side of a vehicle equipped with the vehicular exterior mirror assembly to mount the vehicular exterior rearview mirror assembly at the vehicle. A mirror head accommodates a mirror reflective element and is mounted at the mounting structure via an adjustment mechanism. With the vehicular exterior rearview mirror assembly mounted at the vehicle, the mirror head is movable relative to the mounting structure between (i) a retracted position, where the mirror head is positioned at the side of the vehicle so that the mirror reflective element provides a rearward view to a driver of the vehicle that is at least rearward and along the side of the vehicle, and (ii) an extended position, where the mirror head is extended from the retracted position outward from the side of the vehicle to provide a different rearward view to the driver of the vehicle, such as for when the vehicle is towing a trailer. The mirror head is closer to the side of the vehicle at which the mounting structure is attached when in the retracted position as compared to the extended position. The mounting structure includes a rail. When the mirror head is moved between the retracted position and the extended position, the mirror head moves along the rail of the mounting structure. The adjustment mechanism is operable to move the mirror head relative to the mounting structure between the retracted position and the extended position. The adjustment mechanism includes an actuator disposed at the mirror head, and the actuator is electrically operable to pivotally adjust a driving link. The driving link includes (i) a first end pivotally attached at the mirror head, and (ii) a second end pivotally attached at a first end of a pivot link. The pivot link includes a second end pivotally attached at the mounting structure. When the actuator electrically operates to pivotally adjust the driving link, the driving link pivots relative to the first end of the pivot link to impart movement of the actuator and the mirror head along the rail between the retracted position and the extended position.

These and other objects, advantages, purposes and features of the present invention will become apparent upon review of the following specification in conjunction with the drawings.

### BRIEF DESCRIPTION OF THE DRAWINGS

FIG. 1 is a plan view of an exterior rearview mirror assembly mounted at the side of a vehicle;

FIG. 2 is a perspective view of an adjustment mechanism for moving the mirror head of the exterior rearview mirror assembly of FIG. 1 along a mounting arm between a retracted state and an extended state;

FIG. 3A is a perspective view of the adjustment mechanism of FIG. 2 when the mirror head is in the retracted state;

FIG. 3B is a perspective view of the adjustment mechanism of FIG. 2 when the mirror head is in the extended state;

FIG. 4 is a plan view of another exterior rearview mirror assembly mounted at the side of a vehicle and having a dual-arm mounting structure;

FIG. 5A is a perspective view of an adjustment mechanism for moving the mirror head of the exterior rearview mirror assembly of FIG. 4 along the dual-arm mounting structure when the mirror head is in a retracted state; and

FIG. 5B is a perspective view of the adjustment mechanism of FIG. 5A when the mirror head is in an extended state.

### DESCRIPTION OF THE PREFERRED EMBODIMENTS

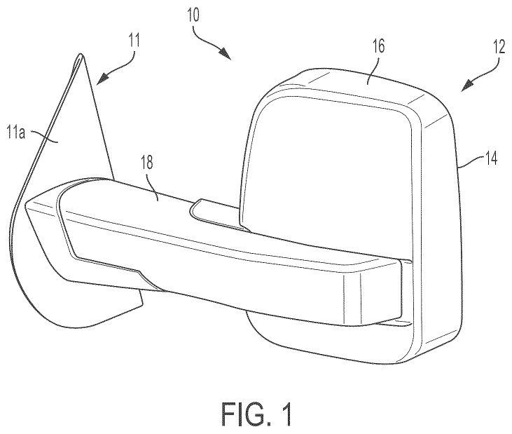

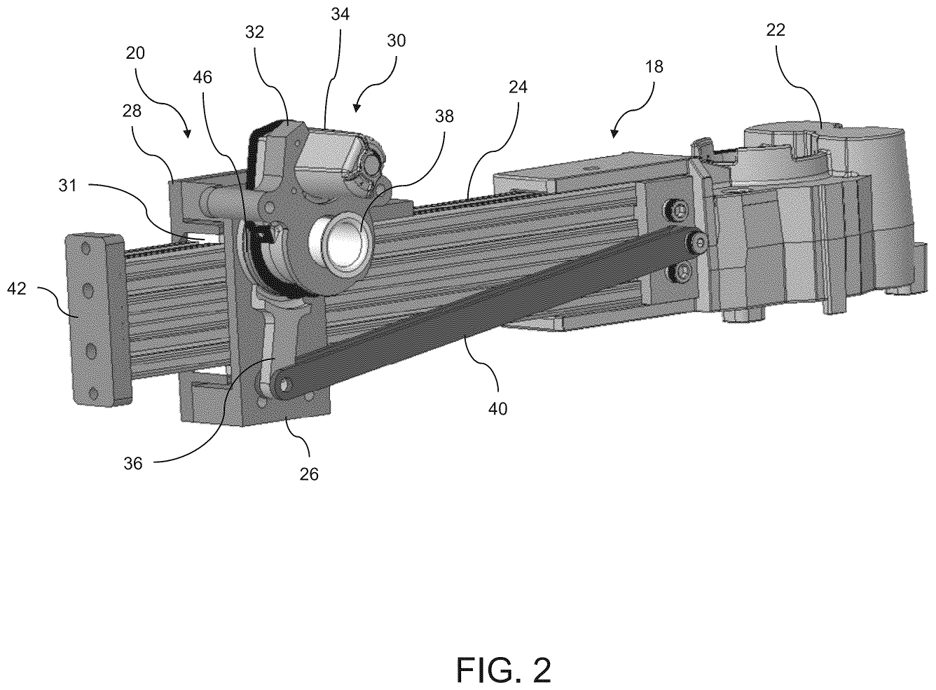

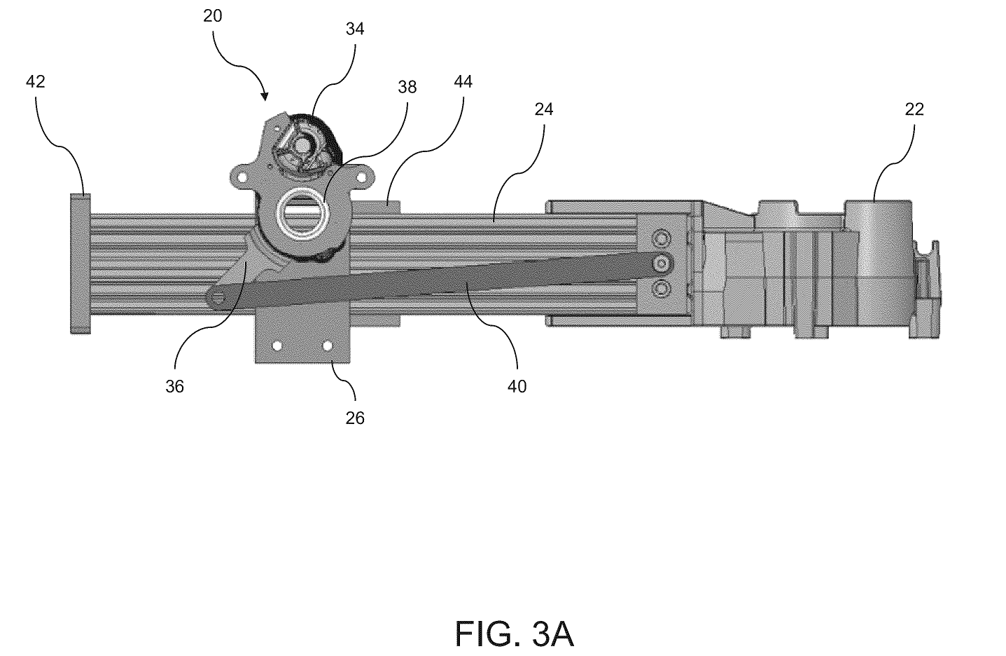

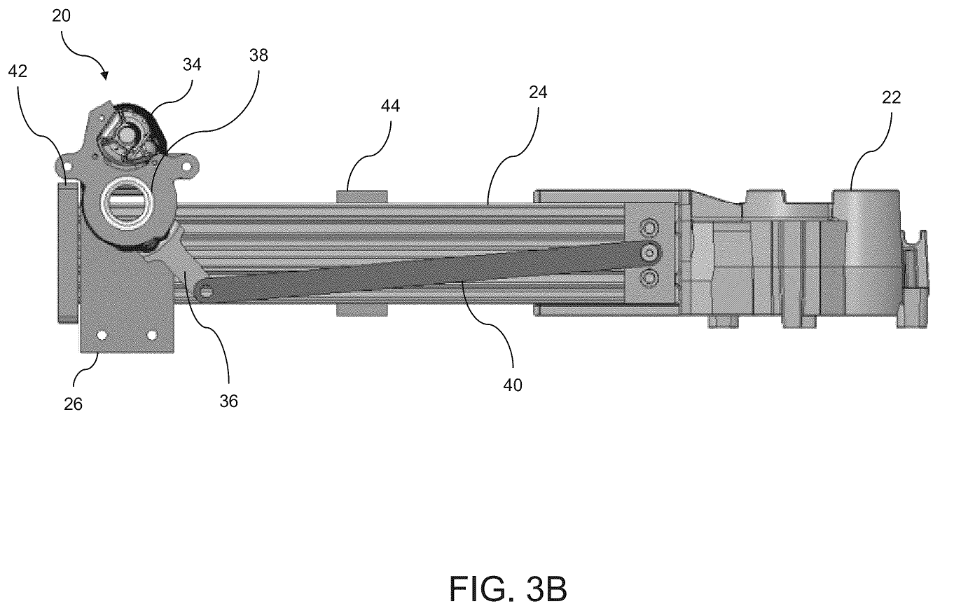

Referring now to the drawings and the illustrative embodiments depicted therein, an exterior rearview mirror assembly 10 for a vehicle 11 includes a mirror head 12 having a mirror reflective element 14 received in and/or supported at or by a mirror shell or casing 16 (FIG. 1). The mirror head 12 may be adjustably mounted at a mounting structure or arm 18 at a side 11a of the vehicle 11 and adjustable via an adjustment mechanism or device 20 having an electrically operable actuator 30 (FIG. 2) that adjusts the mirror head between a retracted state (FIG. 3A) and an extended state (FIG. 3B). For example, the adjustment mechanism 20 may be housed or accommodated within the mirror head 12 and thus move together and in tandem with the mirror head between the retracted state and the extended state. The mounting arm 18 of the mirror assembly 10 is mounted at the side 11a of the host or subject vehicle 11, with the reflective element 14 providing a rearward field of view along the respective side of the vehicle to the driver of the vehicle. When the mirror head 12 is in the retracted state, the mirror reflective element 14 provides a first rearward field of view along the side 11a of the vehicle 11 and, when the mirror head 12 is in the extended state, the mirror head 12 is moved from the retracted state further outboard of the side 11a of the vehicle 11 to provide a second rearward field of view along the side 11a of the vehicle 11, such as a wider field of view that extends further outward from the side 11a of the vehicle 11 than the first field of view. For example, the mirror head 12 may be movable between the retracted state and the extended state responsive to a user input within the vehicle and actuatable by the driver of the vehicle.

Referring to FIGS. 2, 3A and 3B, the mounting arm 18 includes a base portion 22 that mounts at the side 11a of the vehicle and a rail or track portion 24 extending from the base portion 22 to support the mirror head 12 outboard of the side of the vehicle. The mounting arm or structure 18 may enable power folding and/or manual pivoting of the mirror head 12 relative to the side of the vehicle, such that the mirror head 12 may be pivotable between a folded or park position, where the mirror head 12 is disposed along the side of the vehicle so that the mirror reflective element 14 faces the side of the vehicle, and a deployed or use position, where the mirror head 12 is pivoted out from the side of the vehicle so that the mirror reflective element 14 provides the field of view rearward and along the side of the vehicle to the driver. For example, the rail 24 may be pivotable relative to the base portion 22 to move the mirror head 12 between the folded position and the deployed position, or the base portion 22 or a part of the base portion 22 may be pivotable relative to the side of the vehicle to move the mirror head 12 between the folded position and the deployed position. With the mounting arm 18 extended from the side of the vehicle (i.e., when the mirror head is in the deployed position), the mirror head is adjustable between the retracted state and the extended state via operation of the adjustment mechanism 20 to move the mirror head 12 along the rail 24. The rail 24 may comprise any suitable guiding member, such as a tubular arm, extruded member, and the like.

The mirror head 12 may be attached to a carrier 26 that is movably disposed along the rail 24. For example, a portion of the mirror casing or a mirror bracket 28 accommodated by the mirror head 12 may be attached to the carrier 26. Optionally, the bracket 28 is joined to the carrier 26 with the rail 24 sandwiched or received between the bracket 28 and the carrier 26, and one or more slider elements or glider elements 31 of the bracket 28 and/or carrier 26 may engage portions of the rail 24 to enable movement of the carrier 26 and bracket 28 (and therefore the mirror head 12) along a longitudinal axis of the rail 24. In the illustrated example, respective upper and lower portions of the rail 24 include tracks or guide portions with the glider elements 31 riding at least partially within the tracks to guide movement of the carrier 26 and mirror head 12 along the rail 24. Thus, movement of the carrier 26 and/or bracket 28 along the longitudinal axis of the rail 24 moves the mirror head 12 between the retracted state and the extended state.

In the illustrated example, an electrically operable actuator 30 is attached to the carrier 26, such as via an actuator bracket 32 attached at the carrier 26, and the actuator 30 is accommodated within the mirror head 12. The actuator 30 includes an electrically operable motor 34 that, when operated, imparts rotational movement or pivotal movement of a first link or driving link or arm 36 about a pivot axis defined by a pivot tube 38 of the actuator 30. An end portion of the driving link 36 distal from the pivot tube 38 is pivotally attached to a first end portion of a second link or pivot link 40. A second end portion of the pivot link 40 distal from the driving link 36 is pivotally attached at the rail 24 or base portion 22.

The position of the second end portion of the pivot link 40 relative to the rail 24 is fixed so that, as the driving link 36 is pivoted about the pivot tube 38, the carrier 26 and bracket 28 are moved along the rail 24 to move the mirror head 12 between the retracted state (FIG. 3A) and the extended state (FIG. 3B). That is, with the mirror head 12 in the retracted state, the adjustment mechanism 20 is at a first position along the rail 24 and, to move the mirror head 12 toward the extended state, the actuator 30 is operated to rotate or pivot the driving link 36 in a first direction about the pivot tube 38 (e.g., counterclockwise in FIG. 3A). As the driving link 36 is pivoted in the first direction, the adjustment mechanism 20 moves along the rail 24 further from the base portion 22 and further from the side of the vehicle, and the pivot link 40 pivots relative to the driving link 36 at the first end portion of the pivot link 40 and the pivot link 40 pivots relative to the rail 24 and/or base portion 22 at the second end portion of the pivot link 40 to accommodate movement of the driving link 36 relative to the pivot link 40. In other words, the actuator 30 is operated to pivot the driving link 36 about the pivot tube 38 in the first direction, which causes the driving link 36 to push against the first end portion of the pivot link 40 and impart translational movement of the adjustment mechanism 20 and the mirror head 12 along the rail 24 toward the extended position.

With the mirror head 12 in the extended state, the adjustment mechanism 20 is at a second position along the rail 24 that is further along the rail 24 from the base portion 22 and side of the vehicle than the first position corresponding to the retracted state. To move the mirror head 12 from the extended state toward the retracted state, the actuator 30 is operated to rotate the driving link in a second direction about the pivot tube 38 that is opposite the first direction (e.g., clockwise in FIG. 3B). As the driving link 36 is pivoted in the second direction, the adjustment mechanism 20 moves along the rail 24 toward the base portion 22 and the side of the vehicle, and the pivot link 40 pivots relative to the driving link 36 at the first end portion of the pivot link 40 and the pivot link 40 pivots relative to the rail 24 and/or base portion 22 at the second end portion of the pivot link 40 to accommodate movement of the driving link 36 relative to the pivot link 40. That is, the actuator 30 is operated to pivot the driving link 36 about the pivot tube 38 in the second direction, which causes the driving link 36 to pull the first end portion of the pivot link 40 toward the adjustment mechanism 20 and impart translational movement of the adjustment mechanism 20 and the mirror head 12 along the rail 24 toward the retracted position.

The pivot link 40 may be relatively long compared to the driving link 36 such that the pivot link 40 rotates relatively little during rotation of the driving link 36. This results in relatively little movement of the pivot link 40 transverse to the rail 24 and allows the adjustment mechanism 20 to be accommodated in relatively small or narrow or low profile packaging along the mounting arm.

One or more travel stops, such as respective bumpers or detents, may be disposed along the rail 24 to engage the adjustment mechanism 20 and stop movement of the mirror head 12 at the extended and retracted positions. For example, a first or outboard travel stop 42 may be disposed at or near an end region of the rail 24 distal from the base portion 22 so that, when the adjustment mechanism 20 engages the outboard travel stop 42, the mirror head 12 is stopped in the extended state. A second or inboard travel stop 44 may be disposed along the rail 24 between the outboard travel stop 42 and the base portion 22 to stop the mirror head 12 in the retracted state. Thus, when the mirror head 12 moves between the extended state and the retracted state, the adjustment mechanism moves along the rail 24 between the outboard travel stop 42 and the inboard travel stop 44, where the motor 34 may be stalled when the adjustment mechanism 20 engages the respective travel stops to stop movement of the mirror head 12.

Further, the angular position of the driving link 36 at the ends of the range of travel may aid in cinching the actuator 30 and provide added stability to the mirror head 12 at the retracted position and the extended position. That is, with the mirror head 12 in one of the extended position and the retracted position, the driving link 36 extends at a respective angle relative to the rail 24 and the direction of travel of the mirror head 12 between positions. The smaller the angle between the driving link 36 (e.g., the longitudinal axis of the driving link 36 between the pivot tube 38 and the pivot link 40) and the rail 24 (e.g., the longitudinal axis of the rail 24 between the adjustment mechanism 20 and the base portion 22), the greater the resistance to manual movement of the mirror head 12.

The actuator 30 may include a clutch element 46 (FIG. 2) between an output element coupled to the motor 34 and the driving link 36 to enable manual movement of the mirror head 12 between the retracted state and the extended state. Further, the clutch element 46 may slip or disengage during electrical operation of the actuator 30 responsive to resistance at the mirror head 12, such as when the mirror head 12 engages an object or due to ice or snow buildup at the mirror assembly. In other words, when the motor 34 is electrically operated to drive the driving link 36, and responsive to resistance at the mirror head 12, the clutch element 46 disengages so that torque or resistance at the driving link 36 is not transferred through the clutch element 46 to the motor 34. When the motor 34 is electrically operated to drive the driving link 36, and with the clutch element 46 engaged, the clutch element 46 transfers motion from the motor 34 to the driving link 36. When the mirror head 12 is manually moved between the retracted state and the extended state, the manual force may be resisted by the non-operating motor 34 (e.g., through a gear train coupled to the output element) and cause the clutch element 46 to disengage, thus allowing the driving link 36 to pivot relative to the output element and the motor 34 and allowing the mirror head 12 to be manually moved along the rail 24. When the mirror head 12 is released, the clutch element 46 may reengage to maintain the mirror head 12 in the manually moved position. For example, the actuator 30 may include a biasing element that biases the clutch element 46 toward engagement. Thus, the clutch element 46 may allow for infinite adjustment or adjustment of the mirror head 12 to virtually any position between the retracted state and the extended state. In some examples, the clutch element 46 may include a detent interface that engages at respective detent positions of the mirror head (e.g. the retracted state and the extended state) to allow the mirror head 12 to be moved to only those detent positions. The detent interface may define one or more intermediate detent positions between the retracted state and the extended state.

In the illustrated example of FIGS. 2, 3A and 3B, the adjustment mechanism 20 may be mounted within the mirror head 12 so that the longitudinal axis of the pivot tube 38 (and thus the pivot axis of the driving link 36) extends generally horizontal and perpendicular to a plane of the mirror reflective element. Accordingly, the driving link 36 may pivot along a plane generally parallel to the mirror reflective element and the pivot link 40 may extend along an inner side of the rail 24 and mounting arm (e.g., facing rearward along the side of the vehicle) or an outer side of the rail 24 and mounting arm (e.g., facing forward along the side of the vehicle). Optionally, the adjustment mechanism may be mounted within the mirror head so that the pivot tube 38 extends generally vertical and parallel to the plane of the mirror reflective element and the pivot link 40 may extend along an upper side of the rail 24 or a lower side of the rail 24. It should be understood that the adjustment mechanism 20 and its associated pivot tube 38, driving link 36 and pivot link 40 may be oriented in any suitable manner relative to the mirror head 12 and the mounting arm.

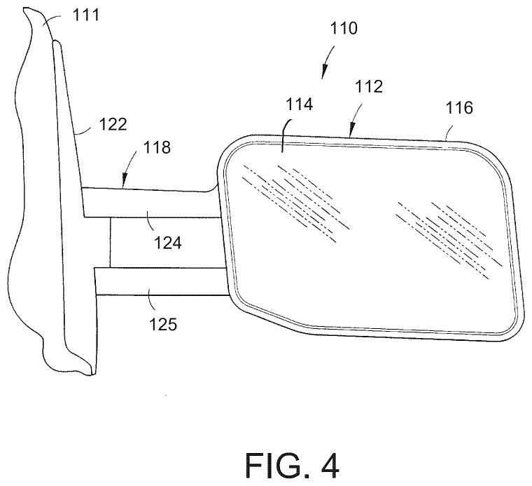

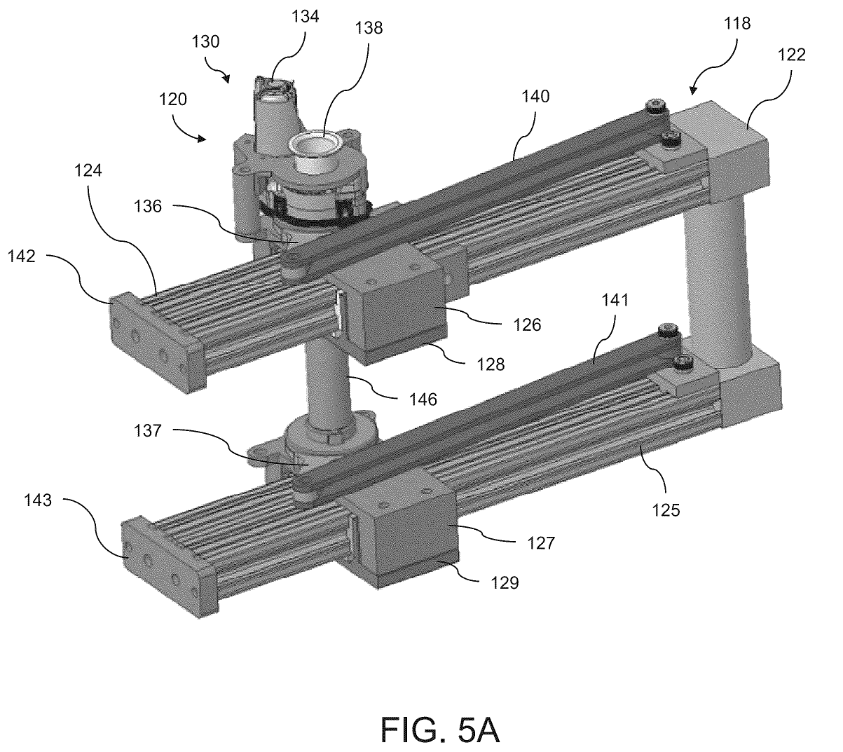

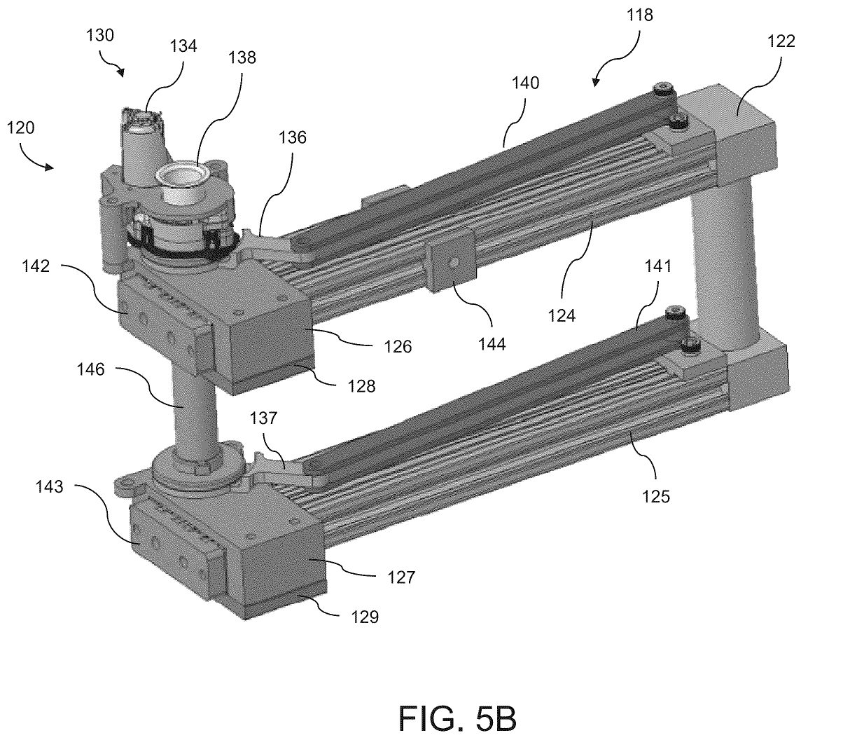

Optionally, the mirror head may be mounted to a dual or twin mounting arm, such as to provide greater structural support to the mirror head when in the extended state as compared to a single mounting arm. For example, and as shown in FIGS. 4, 5A and 5B, an exterior rearview mirror assembly 110 for a vehicle 111 includes a mirror head 112 having a mirror reflective element 114 received in and/or supported at or by a mirror shell or casing 116. The mirror head 112 is adjustably mounted at a mounting structure 118 at the side of the vehicle 111 and adjustable via an adjustment mechanism or device 120 having an electrically operable actuator 130 that adjusts the mirror head 112 between a retracted state (FIG. 5A) and an extended state (FIG. 5B). The mounting structure 118 includes a base portion 122 configured to mount at the side of the vehicle 111, a first or upper rail 124 extending from the base portion 122 and a second or lower rail 125 extending from the base portion 122 parallel to and below the upper rail 124. The upper rail 124 and the lower rail 125 may be pivotable relative to the base portion 122 together and in tandem to move the mirror head between a folded position and a deployed position (i.e., the mirror assembly may have a breakaway feature or may include a powerfold actuator at the base portion). The adjustment mechanism 120 is disposed along the upper rail 124 and the lower rail 125 and coupled to the mirror head 112 for moving the mirror head along the rails between the retracted state and the extended state.

The mirror head 112 may be attached to a first carrier 126 via a first mirror bracket 128 and a second carrier 127 via a second mirror bracket 129, where the first carrier 126 and the first mirror bracket 128 are movable along the upper rail 124 and the second carrier 127 and second mirror bracket 129 are movable along the lower rail 125. Optionally, the mirror head 112 may be attached to the first carrier 126 and the second carrier 127 via one mirror bracket that extends between the first carrier 126 and the second carrier 127. In the illustrated example, the mirror head is moved between the retracted state and the extended state via operation of an electrically operable actuator 130 of the adjustment mechanism 120, where the actuator 130 is disposed at the first carrier 126 along the upper rail 124. As described further below, operation of the actuator 130 imparts movement of the first carrier 126 and the second carrier 127 together and in tandem to move the mirror head between the retracted state and the extended state. Optionally, the actuator 130 may be disposed at the second carrier 127 and/or at a position between the first carrier 126 and the second carrier 127.

The actuator 130 includes an electrically operable motor 134 that, when operated, imparts rotational movement or pivotal movement of a first driving link 136 and a second driving link 137 about a pivot axis defined by a pivot tube 138 of the actuator 130. For example, the motor 134 may drive a clutch element or detent element or drive shaft 146 that extends between the first driving link 136 at the first carrier 126 and the second driving link 137 at the second carrier 127. The first driving link 136 is pivotally attached to a first end portion of a first pivot link 140 (and a distal second end portion of the first pivot link 140 is pivotally attached to the first rail 124 or base portion 122) and the second driving link 137 is pivotally attached to a first end portion of a second pivot link 141 (and a distal second end portion of the second pivot link 141 is pivotally attached to the second rail 125 or base portion 122). When the motor 134 is electrically operated and the first driving link 136 and the second driving link 137 are respectively rotated or pivoted relative to the first pivot link 140 and the second pivot link 141, the first carrier 126 and the second carrier 127 move along the upper rail 124 and the lower rail 125 to move the mirror head between the retracted state (FIG. 5A) and the extended state (FIG. 5B). That is, when the actuator 130 is operated to move the mirror head 112 between the retracted state and the extended state, the actuator 130 may drive the drive shaft 146 and cause the first pivot link 136 and the second pivot link 137 to pivot about the pivot tube 138, thus pushing or pulling the adjustment mechanism 120 and the mirror head 112 along the upper rail 124 and the lower rail 125 between positions.

A first outboard travel stop 142 may be disposed at or near an end region of the upper rail 124 distal from the base portion 122 and a second outboard travel stop 143 may be disposed at or near an end region of the lower rail 125 distal from the base portion 122 so that, when the first carrier 126 and the second carrier 127 are at the respective outboard travel stops, the actuator 130 is stopped with the mirror head in the extended state. Optionally, the outboard travel stop may be disposed along only one of the upper rail 124 and the lower rail 125, or one travel stop may be disposed at and extend between both the upper rail 124 and the lower rail 125. An inboard travel stop 144 may be disposed along one or both of the upper rail 124 and the lower rail 125 between the outboard travel stops and the base portion 122 to stop the actuator 130 with the mirror head at the retracted state.

Thus, the adjustment mechanism is operable to move the mirror head between the retracted state and the extended state by imparting rotational movement of the driving link relative to the pivot link to drive the sliding carrier (attached to the mirror head) along the rail. Thus, the adjustment mechanism converts rotational motion of the driving link into linear motion of the mirror head, similar to the motion of a piston. The rotating element of the power extend system (e.g., the driving link driven by the actuator) may be located on the sliding component (e.g., the mirror head and/or carrier) or on the fixed component (e.g., the base portion), such as based on packaging constraints. The inboard and outboard travel stops may be used as a cinching feature to improve mirror stability in the extended and retracted positions. Further, the angular position of the driving link relative to the direction of travel may influence manual adjustment effort and/or cinching force. That is, as the driving link approaches a parallel angular position relative to the direction of travel (e.g., longitudinal axis of the rail), the mechanical disadvantage against being adjusted manually increases, thus resisting movement. The adjustment mechanism utilizes a piston-like movement to allow for smaller packaging space and provide cinching of the actuator to improve mirror stability.

The extendable and retractable mirror assembly may utilize characteristics of the mirror assemblies described in U.S. Pat. Nos. 11,845,383 and/or 11,718,232, and/or U.S. Publication No. US-2023-0012333, and/or U.S. provisional application Ser. No. 63/648,899, filed May 17, 2024, and/or U.S. provisional application Ser. No. 63/710,908, filed Oct. 23, 2024, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mounting structure configured to mount the vehicular exterior rearview mirror assembly at a side of a vehicle;
a mirror head accommodating a mirror reflective element;
wherein, with the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward of the vehicle and (ii) an extended position where the mirror head is extended from the retracted position outward from the side of the vehicle to provide a different rearward view to the driver of the vehicle that is at least rearward of the vehicle, and wherein the mirror head is closer to the side of the vehicle at which the vehicular exterior rearview mirror assembly is mounted when in the retracted position as compared to the extended position;
wherein the mounting structure comprises a rail, and wherein, when the mirror head is moved between the retracted position and the extended position, the mirror head translationally moves along the rail of the mounting structure;
an adjustment mechanism operable to move the mirror head relative to the mounting structure between the retracted position and the extended position;
wherein the adjustment mechanism comprises (i) an actuator disposed at the mirror head, (ii) a driving link having a first end and a second end and (iii) a pivot link having a first end and a second end;
wherein the first end of the driving link is pivotally attached at the mirror head, and wherein the second end of the driving link is pivotally attached at the first end of the pivot link, and wherein the second end of the pivot link is pivotally attached at the mounting structure;
wherein the actuator is electrically operable to pivotally adjust the first end of the driving link relative to the mirror head; and
wherein, with the vehicular exterior rearview mirror assembly mounted at the side of the vehicle, and when the actuator is electrically operated to pivotally adjust the first end of the driving link, the second end of the driving link pivots relative to the first end of the pivot link to impart translational movement of the actuator and the mirror head along the rail between the retracted position and the extended position.

2. The vehicular exterior rearview mirror assembly of claim 1, wherein, when the actuator is electrically operated to pivotally adjust the first end of the driving link, the second end of the pivot link pivots relative to the mounting structure to accommodate pivoting of the first end of the pivot link relative to the second end of the driving link.

3. The vehicular exterior rearview mirror assembly of claim 1, wherein the adjustment mechanism comprises a clutch element, and wherein, when the actuator is electrically operated to move the mirror head between the retracted position and the extended position, the clutch element is engaged to drive pivoting of the first end of the driving link, and wherein, when the mirror head is manually moved between the retracted position and the extended position, the clutch element is disengaged to allow the first end of the driving link to pivot relative to the mirror head.

4. The vehicular exterior rearview mirror assembly of claim 3, wherein the clutch element comprises a detent interface, and wherein the detent interface is engaged to retain the mirror head in the retracted position and the extended position.

5. The vehicular exterior rearview mirror assembly of claim 1, wherein a first travel stop is disposed at the rail of the mounting structure, and wherein, when the actuator is electrically operated to move the mirror head from the retracted position toward the extended position, a portion of the adjustment mechanism at the mirror head engages the first travel stop with the mirror head at the extended position to cease electrical operation of the actuator.

6. The vehicular exterior rearview mirror assembly of claim 5, wherein a second travel stop is disposed at the rail of the mounting structure between the first travel stop and the side of the vehicle, and wherein, when the actuator is electrically operated to move the mirror head from the extended position toward the retracted position, the portion of the adjustment mechanism at the mirror head engages the second travel stop with the mirror head at the retracted position to cease electrical operation of the actuator.

7. The vehicular exterior rearview mirror assembly of claim 1, wherein a translational position of the second end of the pivot link along the rail of the mounting structure is fixed.

8. The vehicular exterior rearview mirror assembly of claim 1, wherein the second end of the pivot link is pivotally attached at the rail of the mounting structure.

9. The vehicular exterior rearview mirror assembly of claim 1, wherein the mirror head is mounted to a carrier of the adjustment mechanism, and wherein, as the mirror head is moved between the retracted position and the extended position, the carrier translationally moves along the rail of the mounting structure, and wherein the actuator is mounted to the carrier at the mirror head.

10. The vehicular exterior rearview mirror assembly of claim 1, wherein the rail comprises an upper rail and a lower rail, and wherein the driving link comprises (i) an upper driving link pivotally attached at the mirror head and (ii) a lower driving link pivotally attached at the mirror head, and wherein the pivot link comprises (a) an upper pivot link pivotally attached at the upper driving link and pivotally attached at the upper rail and (b) a lower pivot link pivotally attached at the lower driving link and pivotally attached at the lower rail.

11. The vehicular exterior rearview mirror assembly of claim 10, wherein the actuator is electrically operable to pivotally adjust the upper driving link and the lower driving link relative to the mirror head together and in tandem with one another, and wherein, when the actuator is electrically operated to pivotally adjust the upper driving link and the lower driving link, the upper driving link pivots relative to the upper pivot link and the lower driving link pivots relative to the lower pivot link to impart translational movement of the actuator and the mirror head along the rail between the retracted position and the extended position.

12. The vehicular exterior rearview mirror assembly of claim 1, wherein the adjustment mechanism is operable to adjust the mirror head relative to the mounting structure in response to a user input disposed in the vehicle, and wherein the user input is actuatable by the driver of the vehicle.

13. A vehicular exterior rearview mirror assembly, the vehicular exterior rearview mirror assembly comprising:
a mounting structure configured to mount the vehicular exterior rearview mirror assembly at a side of a vehicle;
a mirror head accommodating a mirror reflective element;
wherein, with the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward of the vehicle and (ii) an extended position where the mirror head is extended from the retracted position outward from the side of the vehicle to provide a different rearward view to the driver of the vehicle that is at least rearward of the vehicle, and wherein the mirror head is closer to the side of the vehicle at which the vehicular exterior rearview mirror assembly is mounted when in the retracted position as compared to the extended position;
wherein the mounting structure comprises a rail, and wherein, when the mirror head is moved between the retracted position and the extended position, the mirror head translationally moves along the rail of the mounting structure;
an adjustment mechanism operable to move the mirror head relative to the mounting structure between the retracted position and the extended position;
wherein the adjustment mechanism is operable to adjust the mirror head relative to the mounting structure in response to a user input disposed in the vehicle, and wherein the user input is actuatable by the driver of the vehicle;
wherein the adjustment mechanism comprises (i) an actuator disposed at the mirror head, (ii) a driving link having a first end and a second end and (iii) a pivot link having a first end and a second end;
wherein the first end of the driving link is pivotally attached at the mirror head, and wherein the second end of the driving link is pivotally attached at the first end of the pivot link, and wherein the second end of the pivot link is pivotally attached at the mounting structure;
wherein the actuator is electrically operable to pivotally adjust the first end of the driving link relative to the mirror head;
wherein, with the vehicular exterior rearview mirror assembly mounted at the side of the vehicle, and when the actuator is electrically operated to pivotally adjust the first end of the driving link, the second end of the driving link pivots relative to the first end of the pivot link to impart translational movement of the actuator and the mirror head along the rail between the retracted position and the extended position; and
wherein the adjustment mechanism comprises a clutch element, and wherein, when the actuator is electrically operated to move the mirror head between the retracted position and the extended position, the clutch element is engaged to drive pivoting of the first end of the driving link, and wherein, when the mirror head is manually moved between the retracted position and the extended position, the clutch element is disengaged to allow the first end of the driving link to pivot relative to the mirror head.

14. The vehicular exterior rearview mirror assembly of claim 13, wherein, when the actuator is electrically operated to pivotally adjust the first end of the driving link, the second end of the pivot link pivots relative to the mounting structure to accommodate pivoting of the first end of the pivot link relative to the second end of the driving link.

15. The vehicular exterior rearview mirror assembly of claim 13, wherein the clutch element comprises a detent interface, and wherein the detent interface is engaged to retain the mirror head in the retracted position and the extended position.

16. The vehicular exterior rearview mirror assembly of claim 13, wherein a first travel stop is disposed at the rail of the mounting structure, and wherein, when the actuator is electrically operated to move the mirror head from the retracted position toward the extended position, a portion of the adjustment mechanism at the mirror head engages the first travel stop with the mirror head at the extended position to cease electrical operation of the actuator, and wherein a second travel stop is disposed at the rail of the mounting structure between the first travel stop and the side of the vehicle, and wherein, when the actuator is electrically operated to move the mirror head from the extended position toward the retracted position, the portion of the adjustment mechanism at the mirror head engages the second travel stop with the mirror head at the retracted position to cease electrical operation of the actuator.

17. The vehicular exterior rearview mirror assembly of claim 13, wherein the mirror head is mounted to a carrier of the adjustment mechanism, and wherein, as the mirror head is moved between the retracted position and the extended position, the carrier translationally moves along the rail of the mounting structure, and wherein the actuator is mounted to the carrier at the mirror head.

18. A vehicular exterior rearview mirror assembly, the vehicular exterior rearview mirror assembly comprising:
a mounting structure configured to mount the vehicular exterior rearview mirror assembly at a side of a vehicle;
a mirror head accommodating a mirror reflective element;
wherein, with the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward of the vehicle and (ii) an extended position where the mirror head is extended from the retracted position outward from the side of the vehicle to provide a different rearward view to the driver of the vehicle that is at least rearward of the vehicle, and wherein the mirror head is closer to the side of the vehicle at which the vehicular exterior rearview mirror assembly is mounted when in the retracted position as compared to the extended position;
wherein the mounting structure comprises an upper rail and a lower rail, and wherein, when the mirror head is moved between the retracted position and the extended position, the mirror head translationally moves along the upper rail and the lower rail of the mounting structure;
an adjustment mechanism operable to move the mirror head relative to the mounting structure between the retracted position and the extended position;
wherein the adjustment mechanism comprises (i) an actuator disposed at the mirror head, (ii) an upper driving link having a first end and a second end, (iii) a lower driving link having a first end and a second end, (iv) an upper pivot link having a first end and a second end and (v) a lower pivot link having a first end and a second end;
wherein the mirror head is mounted to a carrier of the adjustment mechanism, and wherein, as the mirror head is moved between the retracted position and the extended position, the carrier translationally moves along the upper rail and the lower rail of the mounting structure, and wherein the actuator is mounted to the carrier at the mirror head;
wherein the first end of the upper driving link and the first end of the lower driving link are pivotally attached at the mirror head, and wherein the second end of the upper driving link is pivotally attached at the first end of the upper pivot link and the second end of the lower driving link is pivotally attached at the first end of the lower pivot link, and wherein the second end of the upper pivot link is pivotally attached at the upper rail of the mounting structure and the second end of the lower pivot link is pivotally attached at the lower rail of the mounting structure;
wherein the actuator is electrically operable to pivotally adjust the first end of the upper driving link and the first end of the lower driving link relative to the mirror head together and in tandem with one another; and
wherein, with the vehicular exterior rearview mirror assembly mounted at the side of the vehicle, and when the actuator is electrically operated to pivotally adjust the first end of the upper driving link and the first end of the lower driving link, the second end of the upper driving link pivots relative to the first end of the upper pivot link and the second end of the lower driving link pivots relative to the first end of the lower pivot link to impart translational movement of the actuator and the mirror head along the upper rail and the lower rail between the retracted position and the extended position.

19. The vehicular exterior rearview mirror assembly of claim 18, wherein the adjustment mechanism comprises a clutch element, and wherein, when the actuator is electrically operated to move the mirror head between the retracted position and the extended position, the clutch element is engaged to drive pivoting of the first end of the upper driving link and the first end of the lower driving link, and wherein, when the mirror head is manually moved between the retracted position and the extended position, the clutch element is disengaged to allow the first end of the upper driving link and the first end of the lower driving link to pivot relative to the mirror head.

20. The vehicular exterior rearview mirror assembly of claim 19, wherein the clutch element comprises a detent interface, and wherein the detent interface is engaged to retain the mirror head in the retracted position and the extended position.

21. The vehicular exterior rearview mirror assembly of claim 18, wherein a first travel stop is disposed at one or more selected from the group consisting of (i) the upper rail of the mounting structure and (ii) the lower rail of the mounting structure, and wherein, when the actuator is electrically operated to move the mirror head from the retracted position toward the extended position, a portion of the adjustment mechanism at the mirror head engages the first travel stop with the mirror head at the extended position to cease electrical operation of the actuator.

22. The vehicular exterior rearview mirror assembly of claim 21, wherein a second travel stop is disposed between the first travel stop and the side of the vehicle at one or more selected from the group consisting of (i) the upper rail of the mounting structure and (ii) the lower rail of the mounting structure, and wherein, when the actuator is electrically operated to move the mirror head from the extended position toward the retracted position, the portion of the adjustment mechanism at the mirror head engages the second travel stop with the mirror head at the retracted position to cease electrical operation of the actuator.

23. The vehicular exterior rearview mirror assembly of claim 18, wherein the adjustment mechanism is operable to adjust the mirror head relative to the mounting structure in response to a user input disposed in the vehicle, and wherein the user input is actuatable by the driver of the vehicle.
